(19) United States
(12) Patent Application Publication
(10) Pub. No.: US 2024/0208470 A1
(43) Pub. Date: Jun. 27, 2024

(54) VEHICLE WITH SAFETY SENSOR SYSTEM AND SAFETY METHOD

(71) Applicants: Kinotex Sensor GmbH, Igel (DE); BASF SE, Ludwigshafen (DE)

(72) Inventors: Winfried Bindges, Igel (DE); Roland Senninger, Ludwigshafen (DE)

(21) Appl. No.: 18/038,942

(22) PCT Filed: Jan. 14, 2022
(86) PCT No.: PCT/IB2022/050310

§ 371 Date: May 25, 2023

(30) Foreign Application Priority Data
Jan. 13, 2021 (DE) 10 2021 100 445.4

(51) Int. Cl. B60T 7/22; B60T 8/171; B62B 5/04; B66F 9/06; B66F 9/075; B66F 17/00

(52) U.S. Cl. CPC B60T 7/22; B60T 8/171; B62B 5/0404; B66F 9/063; B66F 9/0755; B66F 17/003; B60T 2201/022; B60T 2210/32

(57) ABSTRACT

The invention relates to a vehicle (5) for moving on a surface (25), said vehicle having a safety sensor system for detecting objects or persons within a monitoring space (50) or an environment of the vehicle (5), said safety sensor system being configured to interact with a vehicle controller (30, 40) and to influence a movement of the vehicle (5) via said vehicle controller. The safety sensor system comprises a tactile sensor system (10) having at least one first sensor (11), and a proximity sensor system (20) having at least one second sensor (21), wherein the first sensor (11) and the second sensor (21) are each based on an optical measurement principle. The tactile sensor system (10) or at least one sensor (11) of the tactile sensor system (10) is arranged at a height below the proximity sensor system (20) or of at least one sensor (21) of the proximity sensor system (20), in relation to the surface (25). The invention also relates to a safety method in which, when the vehicle (5) approaches an object or a person and the object or the person enters a predefined safety region or monitoring space (50) of the vehicle (5), the vehicle (5) is first automatically braked as the result of a signal from the proximity sensor system (20), and, in the event of a subsequent potential collision with the object or the person, the vehicle (5) is automatically stopped as the result of a signal from the tactile sensor system (10).

The invention relates to a vehicle having a safety sensor system for detecting objects or persons in a monitoring space or an environment of the vehicle, and to a safety method for braking and stopping and, if necessary, moving back the vehicle.

### PRIOR ART

From DE 10 2004 041 821 A1, a non-contact safety system using ultrasonic or microwave sensors for securing a mechanically controlled handling device is known. The proximity sensors used can comprise ultrasonic or microwave sensors. In addition to non-contact proximity sensors, other safety devices such as contact mats can also be provided. It is further described that a combination of the ultrasonic or microwave sensors for monitoring a zone can be done with another sensor that monitors the same zone but operates based on a different physical principle, e.g., a passive infrared sensor or an ultrasonic sensor. Another non-contact safety system for securing a machine-controlled handling device is known from DE 10 2013 021 387 A1. The system operates on the basis of a capacitive sensor system.

DE 10 2018 110 852 A1 describes a device as well as a method for securing a mechanically or automatically controlled movable device, in particular a handling device such as a robot or an AGV. For this purpose, a safety sensor system for detecting objects in a working space, a distance or an environment of the device is provided, which comprises a tactile sensor system with at least one first sensor and a proximity sensor system with at least one second sensor. The first sensor and the second sensor are each based on an optical measurement principle. In addition, a method for securing a mechanically or automatically controlled movable device, in particular a handling device such as a robot or an AGV, is described therein, wherein the device is provided with a safety sensor system in the form of a two-stage collision sensor system for detecting objects in the working space or an environment of the device.

Personal protection devices for logistics areas in which pedestrians and industrial trucks may be present at the same time must at least comply with Performance Level c according to DIN EN ISO 13849-1 “Safety of machinery; Safety-related parts of control systems, Part 1: General principles for design”.

Tactile sensors based on an optical measuring principle that can be used as pressure sensors, collision deformation sensors or impact detection sensors are principally known from U.S. Pat. No. 5,917,180, 6,607,212 B1, 7,313,972 B2, 6,593,588 B1 or 6,568,273 B2.

The vehicles and safety systems known from the prior art do not always allow reliable detection of obstacles near the surface on which the vehicle is moving, such as, for example, detection of a person's feet or legs, and are also limited to stopping the vehicle.

### SUMMARY AND ADVANTAGES OF THE INVENTION

The invention relates to a vehicle according to claim 1 and a method according to claim 13.

Advantageous refinements of the invention are the subject matter of the dependent claims.

Thus, it is advantageous if the tactile sensor system or at least one sensor of the tactile sensor system is arranged at a height in a range from 1 cm to 50 cm, in particular 3 cm to 30 cm, in relation to the surface, and if the proximity sensor system or at least one sensor of the proximity sensor system is arranged at a height in a range from 20 cm to 1.5 m, in particular 40 cm to 1.2 m, in relation to the surface. As a result, the tactile sensor system is optimized for detecting obstacles close to the ground, such as shoes, legs or feet, and stops the movement of the vehicle when triggered, while the proximity sensor system is optimized for detecting obstacles located at a higher level and preferably first slows down the movement of the vehicle. The combination of both is highly beneficial for avoiding injuries and for sensor-supported operation with maximum machine power utilization.

Accordingly, the tactile sensor system or at least one sensor of the tactile sensor system is preferably arranged at least 3 cm, preferably at least 10 cm or at least 30 cm or more, lower than the proximity sensor system or at least one sensor of the proximity sensor system in relation to the surface.

Preferably, the tactile sensor system comprises a plurality of first sensors arranged at least approximately at the same or similar height in relation to the surface. Preferably, the first sensors are arranged laterally spaced apart next to each other.

For this purpose, they are integrated in a sensor strip or an apron, for example.

The proximity sensor system can also have a plurality of second sensors. Preferably, these are also arranged at least approximately at the same or similar height to one another in relation to the surface. Furthermore, the second sensors are preferably also arranged laterally spaced apart next to each other. For this purpose, they can also be integrated in a sensor strip.

Preferably, the second sensors of the proximity sensor system are ToF sensors (“time of flight”).

Preferably, the vehicle is a non-track-bound, in particular manually operated vehicle such as a forklift truck, a pallet truck, an electric low-lift pallet truck, an electric pedestrian stacker with standing platform, an electric side-seat stacker, a platform truck or a low-floor truck.

In the safety method according to the invention, it is preferably provided that after stopping, the vehicle is automatically moved back a certain distance in order to regain distance from the object or person against which the vehicle has abutted. In this way, for example, any jamming of a person or part of a person's body that may have occurred initially is released again.

When the tactile sensor system is in operation, a permanent analog signal from the tactile sensor system is preferably used for self-monitoring and control. In particular, for redundancy purposes, alternate evaluation of two channels is used.

The proximity sensor system preferably uses ToF sensors only, which are preferably arranged in a protective contour above the tactile sensor system and preferably on separate circuit boards of their own. The ToF sensors used are preferably high-resolution ToF sensors with integrated self-monitoring. This prevents the need for a double arrangement of the sensors. Furthermore, additional proximity sensors are thus not required.

The safety method according to the invention is preferably configured to be diversified and first causes a reduction of the driving speed of the vehicle and then a stop of the vehicle upon a signal of the tactile sensor system. Preferably, the method includes an automatic retraction of the vehicle or a reversing drive over a short distance of typically less than 1 m after stopping. Thus, the vehicle initially remains operable after an approach warning, but slows down.

The tactile sensor system is preferably covered with a flexible layer, in particular a fiber-reinforced silicone mat. This provides mechanical protection, but still allows a local or at least locally limited introduction of force with an effect on a material region that covers the sensor. Light is coupled into this material region preferably all the time, so that the invention can take advantage of increased light intensity in the case of local compaction.

The interface and evaluation electronics or control electronics are preferably arranged spatially apart from the tactile sensor system and the proximity sensor system and positioned in a vehicle-bound manner. Communication with the vehicle controller preferably takes place via BUS coupling.

The safety sensor system provided according to the invention can be designed with redundancy.

Overall, the safety sensor system provided and arranged according to the invention enables the vehicle to achieve a Performance Level (PL) of d in accordance with EN ISO 10218.

### BRIEF DESCRIPTION OF THE DRAWINGS

The invention is explained in more detail with reference to the drawings and the following description.

FIG. 1 shows, as a first exemplary embodiment, a schematic diagram of a side view of a vehicle with an arrangement of the tactile sensor system and the proximity sensor system at different heights.

FIG. 2 shows, as a second exemplary embodiment, a schematic diagram of a side view of an alternative vehicle with an arrangement of the tactile sensor system and the proximity sensor system at different heights.

FIG. 3 shows a schematic diagram of a front view of the vehicle of FIG. 1 with an arrangement of the tactile sensor system and the proximity sensor system at different heights.

FIG. 4 shows a front view of a front region of a vehicle according to FIG. 1 or 2 in a first embodiment.

FIG. 5 shows a front view on a front region of a vehicle according to FIG. 1 or 2 in a second embodiment.

FIG. 6 shows a front view of a front region of a vehicle according to FIG. 1 or 2 in a third embodiment.

FIG. 7 shows a schematic diagram of a top view of a region of a vehicle according to FIG. 1 or 2 from above.

FIGS. 8A and B each show a top view of a horizontal section through a tactile sensor system of an attachment part of a vehicle according to FIG. 1 or 2 in two alternative first embodiments.

FIG. 9 shows a top view of a horizontal section through a front region of a vehicle according to FIG. 1 or 2 in a second embodiment.

FIG. 10 shows a top view of a vertical section through a front region of a vehicle according to FIG. 1 or 2 in a third embodiment.

### DESCRIPTION OF PREFERRED EMBODIMENTS OF THE INVENTION

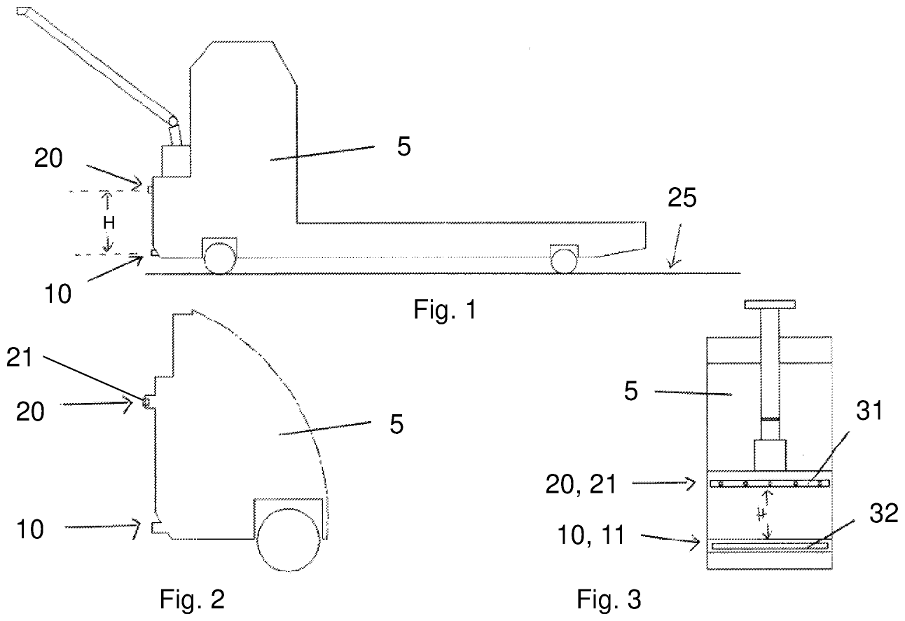

FIG. 1 shows, as a first exemplary embodiment, a vehicle 5 in the form of a pallet truck movable on a roadway or surface 25. The vehicle has a tactile sensor system 10 with a plurality of first sensors 11 which are arranged next to each other parallel to the surface 25 and spaced apart from one another.

Furthermore, the vehicle 5 has a proximity sensor system 20 with a plurality of second sensors 21 which are also arranged next to each other parallel to the surface 25 and spaced apart from one another.

The tactile sensor system 10 of this advantageous exemplary embodiment is arranged relatively close to the surface, here at a height of about 3 cm to 10 cm, while the proximity sensor system 20 is arranged higher, namely at a height of 30 cm to 50 cm. Accordingly, the proximity sensor system is arranged higher with respect to the tactile sensor system by a height H of approximately 25 cm to 40 cm.

FIG. 2 shows, as a second embodiment example, a form of the vehicle 5 alternative to FIG. 1. Here, too, the vehicle 5 has a tactile sensor system 10 with a plurality of first sensors 11 which are arranged next to each other parallel to the surface 25 and spaced apart from one another. Furthermore, here too, the vehicle 5 has a proximity sensor system 20 with a plurality of second sensors 21 arranged next to each other parallel to the surface 25 and spaced apart from one another. The tactile sensor system 10 is arranged relatively close to the surface, for example at a height of 5 cm to 20 cm, while the proximity sensor system 20 is arranged higher, for example at a height of 30 cm to 80 cm. Accordingly, the proximity sensor system is arranged higher in relation to the tactile sensor system by a height H of, for example, 25 cm to 75 cm.

FIG. 3 shows a schematic diagram of a front view of the vehicle 5 of FIG. 1 and shows the arrangement of the tactile sensor system 10 with the associated first sensors 11 and the proximity sensor system 20 with associated second sensors 21 which are arranged higher by a height H. In the embodiment shown, the first sensors 11 are arranged in a sensor strip, in particular a tactile sensor system 32, and the second sensors are arranged in a sensor strip, in particular a proximity sensor system 31, which are spaced apart from each other by the height H and run parallel to each other.

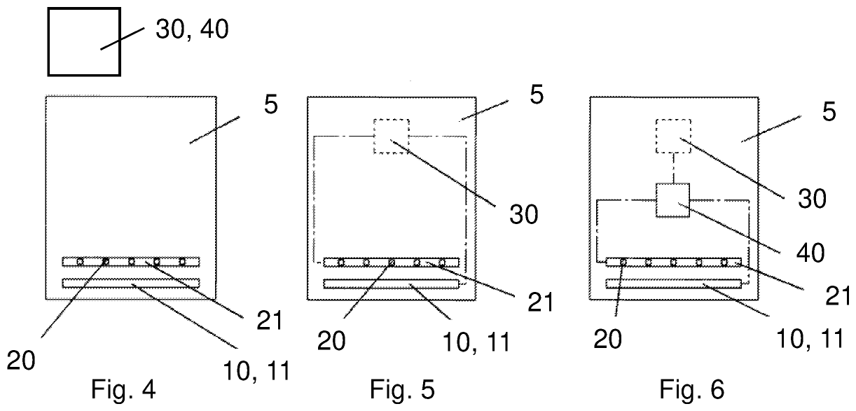

FIGS. 4 to 6 show possible embodiments of the communication of the sensors 11, 21 with a sensor interface or evaluation electronics 30 and vehicle electronics or control electronics 40 connected thereto.

In FIG. 4, the control electronics 40 for communication with the vehicle 5 and the evaluation electronics 30 for communication with the sensors 11, 21 are not vehicle-bound. They communicate wirelessly with the sensors 11, 21 or the tactile sensor system 10 and the proximity sensor system 20, on the one hand, and the vehicle electronics of the vehicle 5 on the other. Purely schematically, an external electronics system is shown above the vehicle 5, in particular with the control electronics 40 and/or the evaluation electronics 30, for example in a control room or another building or vehicle.

In FIG. 5, the sensor interface and an associated evaluation electronics 30 are vehicle-bound and connected to the sensors 11, 21 or the tactile sensor system 10 and the proximity sensor system 20 via corresponding lines. The evaluation electronics can also be integrated in the tactile sensor system 10 and/or the proximity sensor system 20, so that in this case, the reference sign 30 in FIG. 5 stands for a sensor interface, i.e., an interface for preferably wireless communication with control electronics of the vehicle.

In FIG. 6, the control electronics 40 of the vehicle 5 is vehicle-bound. The signals from the sensors 11, 21 or the tactile sensor system 10 and the proximity sensor system 20 are evaluated via a sensor interface in associated evaluation electronics 30. The sensor interface is connected to control electronics 40, which in turn is connected to or communicates with the vehicle electronics.

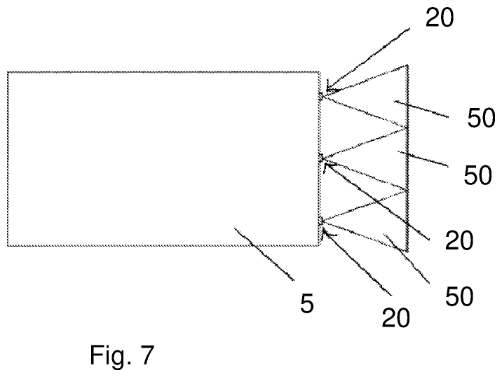

FIG. 7 shows a schematic diagram of a top view of a region of a vehicle 5 according to FIG. 1 or 2 from above. A plurality of second sensors 20 is arranged on the front of the vehicle 5 in the form of spaced ToF sensors, each of which monitors a monitoring space 50 ahead. The ToF sensors can be integrated in the sensor strip, in particular the proximity sensor system 31, or can be mounted individually.

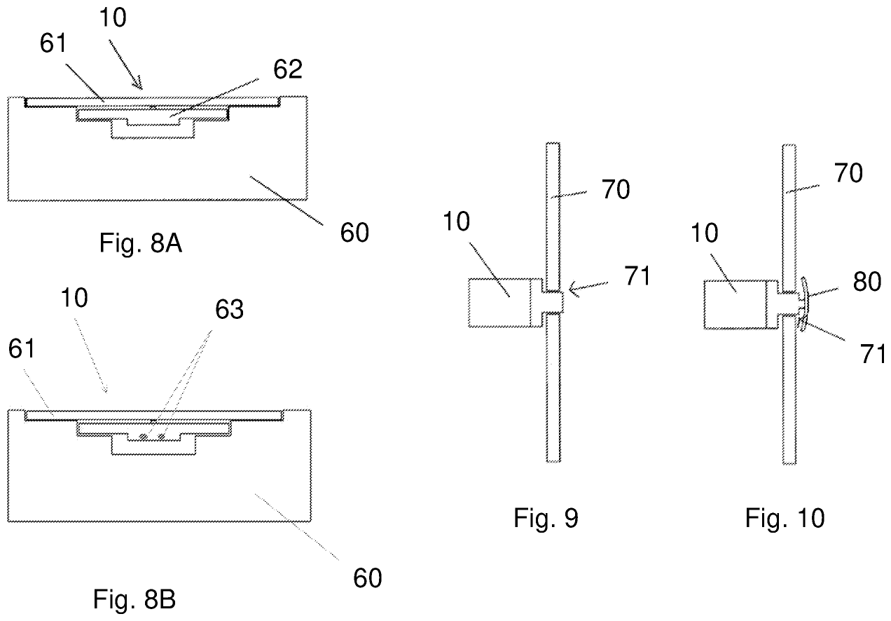

FIG. 8A shows a top view of a horizontal section through a tactile sensor system 10 of an attachment part in the front region of a vehicle 5 according to FIG. 1 or 2 in a first embodiment. On the front side of the vehicle 5, a receptacle 60 is provided in the attachment part, in which receptacle the sensor board 62 is inserted on which a first sensor 11 or the entire tactile sensor system 10 is located. Furthermore, a suitable cover 61 is provided which covers the sensor board 62. The cover 61 is thus to be regarded as a layer, preferably a fiber-reinforced silicone film.

In FIG. 8B, an alternative first embodiment of a tactile sensor system 10 is used. A pair of optical fibers 63 is laid and fixed freely on a substrate. Here, light from an infrared light source, preferably with a wavelength of 800 nm to 1000 nm, is coupled into a scattering medium, preferably a silicone or polyurethane foam, by means of an optical fiber 63. The light scattered in the scattering medium is picked up by means of a second optical fiber 63 and guided to a photoelectric converter.

The latter converts the light energy into electrical energy, which is then processed accordingly. For example, photo diodes, photo transistors, CCD or CMOS camera modules, etc. can be used as photoelectric converters. A sensor cell of this preferred sensor configuration is always formed by a transmitter and a receiver optical fiber 63.

It is advantageous that the sensor configuration with optical fiber 63 allows:
a multi-channel setup with a multiplicity of sensor cells,
a permanent monitoring of each sensor cell, which allows a high performance level classification,
placement of the evaluation electronics spatially separated from the sensor cells,
the use of optical fibers 63 without EMC problems,
a slim and space-saving structure of a sensor strip consisting of a multiplicity of sensors,
retrofittings of the sensor configuration with optical fibers 63 in existing vehicles.

FIG. 9 shows a top view of a horizontal section through a cutout with a sensor 10 in the front region of a vehicle according to FIG. 1 or 2 in a second embodiment. In this case, in contrast to FIG. 8, no receptacle 60 previously shown here is provided, but the first sensor 10 is mounted on the rear side of the front apron 70 of the vehicle and inserted into a slot 71 or a recess of the front apron 70, wherein for this purpose, too, in particularly preferred embodiments, a receptacle is provided for mounting the sensors, at least in groups, on body parts.

In continuation of the embodiment of FIG. 9, FIG. 10 shows that the first sensor 10 is additionally protected by a protective cover 80.

The first sensors 11 of the tactile sensor system 10 are based on an optical measuring principle, i.e., optical tactile sensors, for example, for detecting contact between the vehicle 5 and an object or a person are used. Preferably, optical scattered light sensors are used. The first sensors 11 of the tactile sensor system 10 can also be configured by means of an optical sensor.

For the second sensors 21, which are also based on an optical measurement principle, several optical measurement principles are possible. Preferably, time-of-flight sensors, reflection sensors and/or structured light sensors are used.

The sensors 11, 21 used can evaluate either only one measuring point or multiple measuring points.

Preferably, it is provided that the first sensors 11 and/or the second sensors 21 are subject to continuous self-monitoring. In addition (or, if necessary, also as an alternative to this continuous self-monitoring), these sensors 11, 21 are preferably each designed with at least two channels and thus redundantly.

The optical proximity sensors 21 used preferably detect approaches already at a distance of 0.3 m or more, preferably 0.5 m or more. This means that the vehicle can be braked in good time. At the same time, however, the vehicle 5 can still be operated and maneuvered.

However, if a touch between the vehicle 5 and an object or person is detected by the tactile sensor system 10, the vehicle 5 is first stopped. A possible overrun of the vehicle 5 is now excluded as success of the invention.

In a preferred embodiment of the invention, the proximity sensor system 20 and/or the tactile sensor system 10 are designed diversely. For this purpose, the proximity sensor system and/or the tactile sensor system are not only designed redundantly, but different sensor implementations are deliberately used and no identical individual systems or components are used.

In particular, it is preferably provided that the proximity sensor system is designed diversely in terms of its resolution and/or its detected range so that, for example, for the detection of a foot or a leg of a person or for the detection of both legs of a person, in each case a plurality of second sensors 21, preferably in the form of ToF sensors, provide measured values for reliable plausibility checking of the detected distance, and the travel speed of the vehicle 5 is then reduced.

The vehicle 5 is preferably a manually controlled vehicle. However, it can also be an AGV or a self-propelled vehicle. The primary objective is to avoid a collision of the moving vehicle with persons and other moving or stationary objects.

In the above exemplary embodiments, it is preferably provided that the individual electronic components are connected in the usual manner via a CAN bus which receives or collects and transmits the signals.

As explained, the first sensors 11 are preferably arranged on a sensor board 62 which is connected to the vehicle 5 via a board receptacle 60 (see FIG. 8A or B). In addition, a cover for the sensor board 62 is preferably provided in the form of a plate 61 or mat, in particular a silicone mat, an apron 70 or a strip. In a preferred embodiment, the vehicle 5 has an apron 70 on its front side, which is provided with one or more slots 71, openings or recesses, wherein the tactile sensor system or individual first sensors are inserted or accommodated therein. Preferably, the tactile sensor system 10 or individual inserted first sensors 11 are provided with a protective cover 80 next to it towards the front.

In the safety method according to the invention, when the vehicle 5 approaches an object or a person and the object or person enters a predetermined safety region or the monitoring space 50, the vehicle 5 is first automatically braked as a result of a corresponding signal from the proximity sensor system 20. In the event of a subsequent possible collision of the vehicle 5 with the object or person, the vehicle is then automatically stopped as a result of a corresponding signal from the tactile sensor system 10 and preferably automatically moved back a predetermined distance immediately after stopping in order to increase the distance of the vehicle 5 from the object or person again.

The monitoring space of the proximity sensor system 20 is thus preferably in the range from 5 cm to 50 cm or more. It is preferably in the form of a space belt or arc section.

### REFERENCE LIST

5 vehicle
10 tactile sensor system
11 first sensor
20 proximity sensor system
21 second sensor
25 surface
30 sensor interface, evaluation electronics
31 sensor strip, in particular proximity sensor system
32 sensor strip, in particular tactile sensor system
40 control electronics, vehicle electronics
50 monitoring space
60 receptacle
61 plate
62 sensor board
63 optical fiber
70 front apron
71 slot
80 protective cover

1. A vehicle for moving on a surface (25), wherein the vehicle (5) has a safety sensor system for detecting objects or persons in a monitoring space (50) or an environment of the vehicle (5), the safety sensor system being configured to interact with a vehicle controller (30, 40) and to influence a movement of the vehicle (5) via said vehicle controller, wherein the safety sensor system comprises a tactile sensor system (10) having at least one first sensor (11) and a proximity sensor system (20) having at least one second sensor (21), and wherein the first sensor (11) and the second sensor (21) are each based on an optical measurement principle, characterized in that the tactile sensor system (10) or at least one sensor (11) of the tactile sensor system (10) is arranged at a height below the proximity sensor system (20) or at least one sensor (21) of the proximity sensor system (20) in relation to the surface (25).

2. The vehicle according to claim 1, characterized in that the tactile sensor system (10) or the at least one sensor (11) of the tactile sensor system (10) is arranged at a height in a range from 1 cm to 50 cm, in particular 3 cm to 30 cm, in relation to the surface (25), and in that the proximity sensor system (20) or the at least one sensor (21) of the proximity sensor system (20) is arranged at a height in a range from 20 cm to 150 cm, in particular 40 cm to 120 cm, in relation to the surface (25).

3. The vehicle according to claim 1, characterized in that the tactile sensor system (10) or the at least one sensor (11) of the tactile sensor system (10) is arranged at least 10 cm, in particular at least 30 cm, lower than the proximity sensor system (10) or the at least one sensor (11) of the proximity sensor system (10) in relation to the surface (25).

4. The vehicle according to claim 1, characterized in that the tactile sensor system (10) has a plurality of first sensors (11) which are arranged at least approximately at the same height in relation to the surface (25) and/or, in particular, laterally spaced apart from one another in the form of a sensor strip or an apron (70).

5. The vehicle according to claim 1, characterized in that the proximity sensor system (20) has a plurality of second sensors (21) which, are arranged at least approximately at the same height in relation to the surface (25) and/or spaced apart from one another.

6. The vehicle according to claim 1, characterized in that the at least one or the plurality of first sensors (11) of the tactile sensor system (10) is/are arranged on a sensor board (62) which is connected to the vehicle (5) via a board receptacle (60).

7. The vehicle according to claim 6, characterized in that a cover for the sensor board (62) such as a plate (61) or a flexible layer, in particular a silicone mat, an apron (70) or a strip is provided.

8. The vehicle according to claim 6, characterized in that a means for transmitting a touch of an object or a person by the vehicle (5) or an abutting of the vehicle (5) against an object or a person to the tactile sensor system (10) is provided.

9. The vehicle according to claim 1, characterized in that, on a front side, the vehicle (5) has a plate (61), an apron (70) or a strip which is provided with a slot (71), an opening or a recess, and in that the tactile sensor system (10) or a first sensor (11) of the tactile sensor system (10) is inserted into the slot (71), the opening or the recess, so that through this, transmitting a touch of an object or a person by the vehicle (5) or an abutting of the vehicle (5) against an object or a person to the tactile sensor system (10) takes place.

10. The vehicle according to claim 7, characterized in that the inserted tactile sensor system (10) or the inserted first sensor (11) is provided with a protective cover (80).

11. The vehicle according to claim 1, characterized in that the proximity sensor system (20) comprises one or more ToF sensors as second sensors (21).

12. The vehicle according to claim 1, characterized in that the vehicle (5) is a non-track-bound vehicle and/or a manually guided vehicle such as a forklift truck, a pallet truck, an “automated guided vehicle” (AGV) or a low-floor truck.

13. A safety method, wherein, when a vehicle (5) according to at least one of the preceding claims approaches an object or a person and the object or person enters a predetermined safety region or the monitoring space (50) of the vehicle (5), the vehicle (5) is first automatically braked as a result of a signal from the proximity sensor system (20) and, in the event of a subsequent possible collision with the object or person, the vehicle (5) is automatically stopped as a result of a signal from the tactile sensor system (10).

14. The safety method according to claim 13, characterized in that after stopping, the vehicle (5) automatically moves back a predetermined distance or increases the distance of the vehicle to the object or person.
